(19) United States
(12) Patent Application Publication
(10) Pub. No.: US 2016/0164220 A1
(43) Pub. Date: Jun. 9, 2016

(54) CONNECTOR

(71) Applicant: YAZAKI CORPORATION, Tokyo (JP)

(72) Inventors: Masayuki KATAOKA, Shizuoka (JP); Fuminori SUGIYAMA, Shizuoka (JP)

(73) Assignee: YAZAKI CORPORATION, Tokyo (JP)

(21) Appl. No.: 15/041,414

(22) Filed: Feb. 11, 2016

Related U.S. Application Data
(63) Continuation of application No. PCT/JP2014/073487, filed on Sep. 5, 2014.

(30) Foreign Application Priority Data
Sep. 6, 2013 (JP) 2013-185147

(51) Int. Cl. H01R 13/52; H01R 13/6581; H01R 13/74

(52) U.S. Cl. CPC H01R 13/5202; H01R 13/74; H01R 13/6581

(57) ABSTRACT

A housing has a seal portion configured to seal a boundary between the housing and a mounting member in close contact with the mounting member. The seal portion includes a wall portion being elastically deformable, formed integrally with the housing on a close contact surface side of the housing with the mounting member, and protruding to a close contact surface of the mounting member with the seal portion, and a recessed portion surrounded by the wall portion.

### CROSS REFERENCE TO RELATED APPLICATION

This application is a Continuation of PCT Application No. PCT/JP2014/073487, filed on Sep. 5, 2014, and claims the priority of Japanese Patent Application No. 2013-185147, filed on Sep. 6, 2013, the content of both of which is incorporated herein by reference.

### BACKGROUND

1. Technical Field

The disclosure relates to a connector having a waterproof function.

2. Related Art

Japanese Unexamined Patent Application Publication No. 2012-151067 proposes a connector having a waterproof function. Such a connector is shown in FIGS. 1A and 1B. A connector 100 includes a terminal 101 where a wire W is connected, a housing 110, and a shield shell 120 as shown in FIGS. 1A and 1B. The terminal 101 is housed in a terminal housing chamber 111 of the housing 110 in a state where the tip side is exposed to the front. The wire W has a connecting portion with the terminal 101 and an end portion, housed in the terminal housing chamber 111 of the housing 110, and is drawn out from the rear of the terminal housing chamber 111.

An O ring 130 is interposed between the inner surface of the terminal housing chamber 111 of the housing 110 and the terminal 101. A seal ring 131 is interposed between the inner surface of the terminal housing chamber 111 of the housing 110 and the end portion of the wire W. A unit packing 132 is arranged on the mounting surface of the housing 110 to the mounting member 140 so as to surround the outer periphery of the terminal 101. A shield shell 120 is fitted to the outer periphery of the housing 110. Mounting holes 121 are formed in the shield shell 120. The front end portion of the housing 110 is inserted into a connector mounting hole 141 of the mounting member 140, and a fixing screw inserted into the mounting hole 121 (not shown) is screwed into the mounting member 140, whereby the connector 100 is fixed to the mounting member 140.

When the connector 100 is fixed to the mounting member 140, the unit packing 132 is compressed and deformed by the fastening force of the fixing screw to come into close contact with the mounting member 140. The space between the housing 110 and the mounting member 140 is sealed by the unit packing 132.

### SUMMARY

As in the above-described related connector, when the unit packing 132 being a member separate from the housing 110 is arranged, number of components and assembling man-hours increase.

An object of the disclosure is to provide a connector capable of securely performing the seal between the housing and the mounting member without increasing the number of components and the assembling man-hours.

A connector in accoradance with some embodiments includes a wire, a terminal to which the wire is connected, and a housing fixed to a mounting member with the housing holding the terminal. The housing has a seal portion configured to seal a boundary between the housing and the mounting member in close contact with the mounting member. The seal portion includes: a wall portion being elastically deformable, formed integrally with the housing on a close contact surface side of the housing with the mounting member, and protruding to a close contact surface of the mounting member with the seal portion; and a recessed portion surrounded by the wall portion.

The housing may be a housing having an insulating resin overmolding the terminal and the wire.

The connector may further include a shield shell configured to fix the housing to the mounting member with the seal portion being elastically deformed, and the housing may be a housing having an insulating resin overmolding the terminal, the wire, and the shield shell.

The recessed portion may open to the close contact surface of the mounting member with the seal portion.

The shield shell may be configured to prevent deformation of an outer shape of the housing.

An outer periphery of the terminal other than a tip portion of the terminal, an outer periphery of an end portion of the wire, an inner periphery of a cylindrical-body portion of the shield shell, and a periphery of a root portion of a fixing flange of the shield shell may be filled with the insulating resin without any gap.

The wall portion of the housing fixed to the mounting member may be in pressure contact with the close contact surface of the mounting member with the seal portion with the wall portion being compressed and deformed.

An internal pressure of the recessed portion of the housing fixed to the mounting member sealed by the mounting member may be lower than an external pressure outside the recessed portion.

According to the above configuration, the seal portion is molded integrally with the housing, and therefore the number of components and the assembling man-hours do not increase. Although the housing is formed of a material having a function as the housing, the seal portion has reduced rigidity compared to the other portions of the housing due to the recessed portion surrounded by the wall portion, and is elastically deformed to be in close contact with the mounting member when subjected to a compressive force. Therefore, the seal between the housing and the mounting member can be securely performed without the number of components and the assembling man-hours being increased.

### BRIEF DESCRIPTION OF DRAWINGS

FIG. 1A is a perspective view of a related connector.

FIG. 1B is a cross-sectional view of the related connector.

FIG. 2A is a perspective view of a high-voltage connector according to a first embodiment of the present invention.

FIG. 2B is a main part enlarged view of the seal portion in FIG. 2A.

FIG. 3A is a cross-sectional view of the high-voltage connector in amounted state according to the first embodiment of the present invention.

FIG. 3B is a main part enlarged view in the vicinity of the seal portion in FIG. 3A.

FIG. 4A is a perspective view showing an assembling process of the high-voltage connector according to the first embodiment of the present invention.

FIG. 4B is a perspective view showing an assembling process of the high-voltage connector according to the first embodiment of the present invention.

FIG. 4C is a perspective view showing an assembling process of the high-voltage connector according to the first embodiment of the present invention.

FIG. 5A is a diagram illustrating the principle that the recessed portion adheres to the mounting member by suction according to the first embodiment of the present invention.

FIG. 5B is a diagram illustrating the principle that the recessed portion adheres to the mounting member by suction according to the first embodiment of the present invention.

FIG. 5C is a diagram illustrating the principle that the recessed portion adheres to the mounting member by suction according to the first embodiment of the present invention.

FIG. 6 is a perspective view of a high-voltage connector according to a second embodiment of the present invention.

FIG. 7 is a cross-sectional view of the high-voltage connector in a mounted state according to the second embodiment of the present invention.

FIG. 8A is a perspective view showing an assembling process of the high-voltage connector according to the second embodiment of the present invention.

FIG. 8B is a perspective view showing an assembling process of the high-voltage connector according to the second embodiment of the present invention.

FIG. 8C is a perspective view showing an assembling process of the high-voltage connector according to the second embodiment of the present invention.

FIG. 9A is a perspective view of the high-voltage connector according to a third embodiment of the present invention.

FIG. 9B is a main part enlarged view of the seal portion in FIG. 9A.

FIG. 10A is a cross-sectional view of the high-voltage connector in a mounted state according to the third embodiment of the present invention.

FIG. 10B is a main part enlarged view in the vicinity of the seal portion in FIG. 10A.

FIG. 11A is a perspective view showing an assembling process of the high-voltage connector according to the third embodiment of the present invention.

FIG. 11B is a perspective view showing an assembling process of the high-voltage connector according to the third embodiment of the present invention.

FIG. 11C is a perspective view showing an assembling process of the high-voltage connector according to the third embodiment of the present invention.

FIG. 12A is a perspective view of the high-voltage connector according to a fourth embodiment of the present invention.

FIG. 12B is a main part enlarged view of the seal portion in FIG. 12A.

FIG. 13A is a cross-sectional view of the high-voltage connector in a mounted state according to the fourth embodiment of the present invention.

FIG. 13B is a main part enlarged view in the vicinity of the seal portion in FIG. 13A.

FIG. 14A is a perspective view showing an assembling process of the high-voltage connector according to the fourth embodiment of the present invention.

FIG. 14B is a perspective view showing an assembling process of the high-voltage connector according to the fourth embodiment of the present invention.

FIG. 14C is a perspective view showing an assembling process of the high-voltage connector according to the fourth embodiment of the present invention.

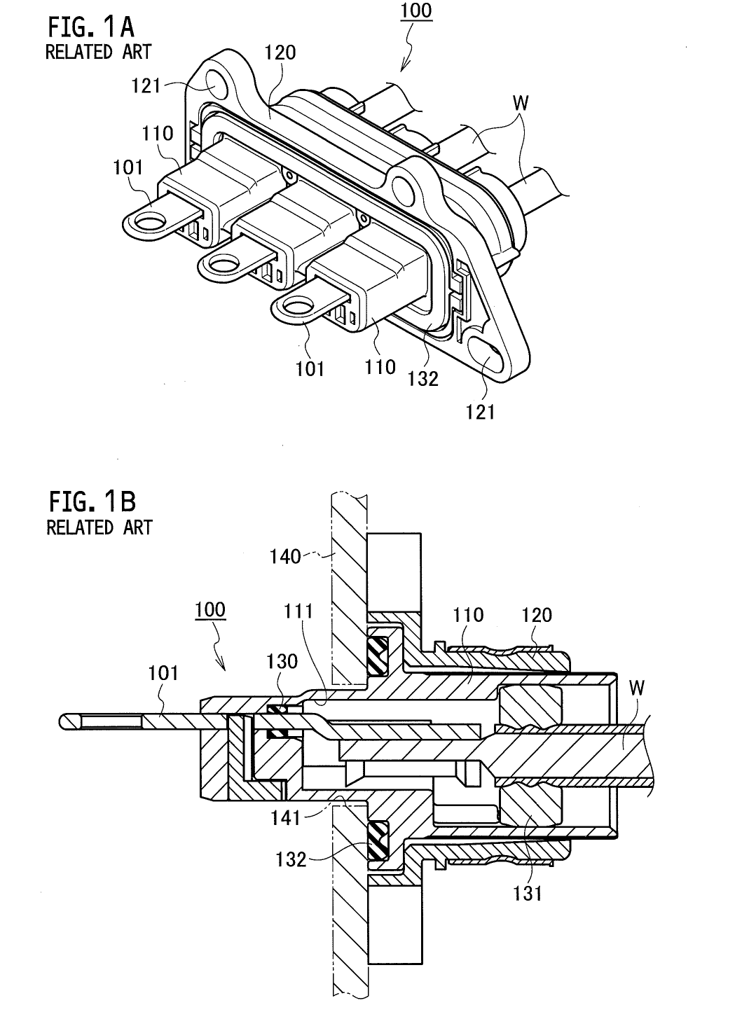

### DETAILED DESCRIPTION

In the following, embodiments of the present invention will be described in detail with reference to the drawings.

### First Embodiment

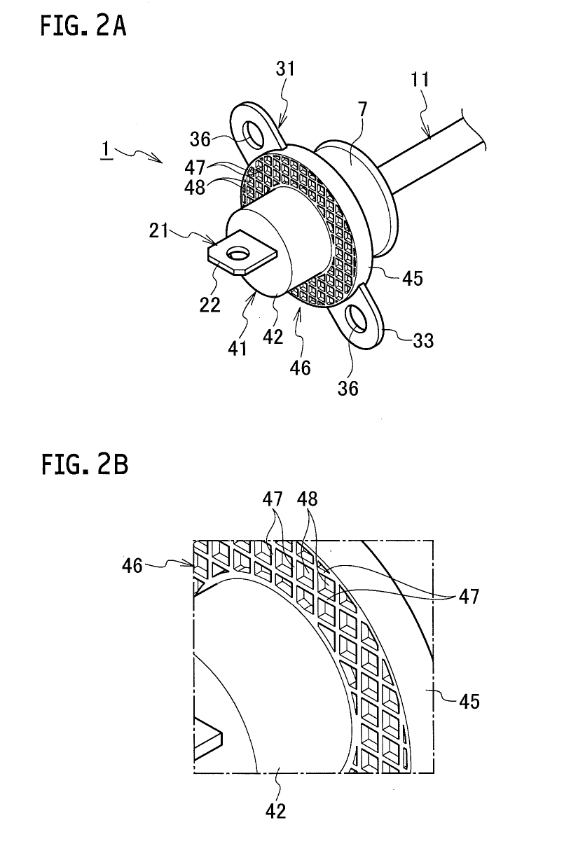

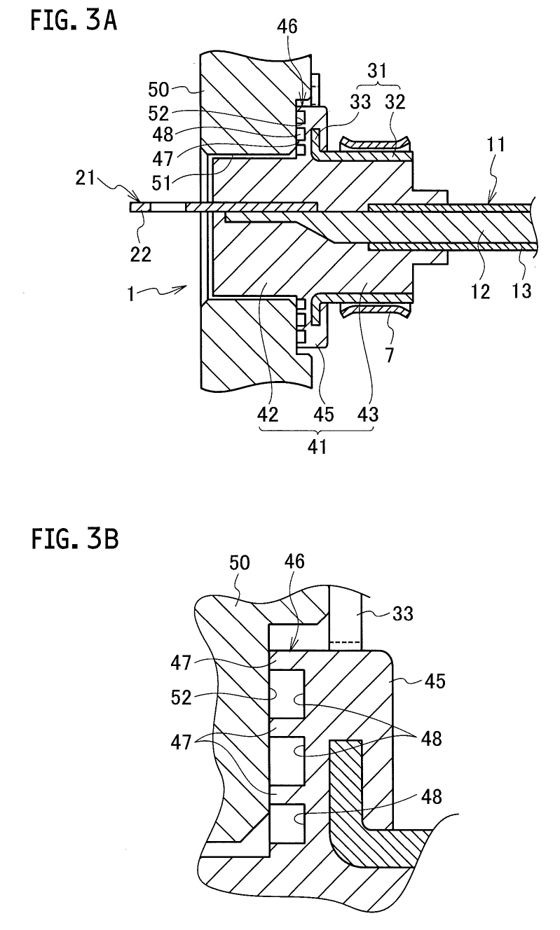

FIGS. 2A to 5C illustrate a first embodiment of the present invention. As shown in FIGS. 2A to 3B, a high-voltage connector 1 being a connector is directly attached to an equipment case 50 being a mounting member of an inverter device of an electric vehicle. The equipment case 50 is formed of a shield member that shields electromagnetic waves. The equipment case 50 includes a connector mounting hole 51 penetrating the inside, and a seal recess 52 so as to surround the periphery of the connector mounting hole 51.

The high-voltage connector 1 includes a terminal 21 where a wire 11 is connected, a shield shell 31, and an integrated housing 41 being a housing.

The wire 11 is a shield wire. Specifically, the wire 11 includes a conductor 12, and a coating layer 13 covering the outer periphery of the conductor 12 and having a shield layer (not shown). The conductor 12 is exposed in the end portion of the wire 11. The exposed portion of the conductor 12 and the terminal 21 are connected by welding and the like. In the end portion of the wire 11, although not shown, the shield layer (not shown) is exposed to the outer surface of the coating layer 13 by folding back.

The terminal 21 is a component for performing the energizing function. The terminal 21 includes a tip portion 22 exposed to the outside of the integrated housing 41. The exposed tip portion 22 protrudes from the connector mounting hole 51 into the equipment case 50, and is connected to the counterpart terminal of the inverter device and the like.

The shield shell 31 is formed of a conductive metal, and shields electromagnetic waves. The shield shell 31 includes a cylinder-shaped cylindrical-body portion 32, and a fixing flange portion 33 protruding in a flange shape from the front end position of the cylindrical-body portion 32. The cylindrical-body portion 32 is arranged so as to cover the outer periphery of the end portion of the wire 11. The fixing flange portion 33 includes fixing holes 36 in a plurality of positions. The fixing screws (not shown) inserted into the fixing holes 36 are fastened to the equipment case 50. Thus, as shown in FIGS. 3A and 3B, the high-voltage connector 1 is fixed to the equipment case 50. One end of the shield member (braided wire and the like) is covered on the outer surface of the cylindrical-body portion 32, and the caulking ring 7 is caulked and fixed thereon. The other end of the shield member (braided wire and the like) is connected and fixed to the shield layer of the end portion of the wire 11. That is, the conductor 12 exposed from the end portion of the wire 11 and the terminal 21 connected thereto are shielded by the shield member (the braided wire and the like), the shield shell 31, and the equipment case 50.

The terminal 21, the wire 11, and the shield shell 31 are overmolded with the insulating resin, whereby the integrated housing 41 is formed. In the integrated housing 41, the insulating resin forming the integrated housing 41 fills, without any gap, the outer periphery of the terminal 21 other than the tip portion, the outer periphery of the end portion of the wire 11, the inner periphery of the cylindrical-body portion of the shield shell 31, and the periphery of the root portion of the fixing flange. Thus, the integrated housing 41 fixes the terminal 21, the end portion of the wire 11, and the shield shell 31 to one another.

The integrated housing 41 fills the outer periphery of the terminal 21 and the wire 11 without any gap, whereby the space between the integrated housing 41 and the terminal 21, and the space between the integrated housing 41 and the wire 11 are made waterproof. The integrated housing 41 insulates these components from each other (for example, between the terminal 21 and the shield shell 31).

The integrated housing 41 is formed of the resin material having the hardness equal to or more than that of the rubber used as the seal portion material (acrylic and the like) and the hardness equal to or less than that of the resin material of the general housing (for example, PBT) so that the shield shell 31 has a deformation preventing function (strength reinforcing function) on the outer shape of the integrated housing 41. The integrated housing 41 is, for example, formed of an elastomer-based resin material. As the resin material, for example, the styrene-based, olefin-based, vinyl chloride-based, polyester-based, polyurethane-based, and nylon-based elastomer are used as a base, and the material obtained by blending the adhesive having the hydroxyl group (OH group) representing the hydrogen bond to the metal with the base elastomer can be used.

The integrated housing 41 includes a cylindrical front housing portion 42 covering the outer periphery of the terminal 21, a cylindrical rear housing portion 43 arranged in the cylindrical-body portion 32 of the shield shell 31, and a ring-shaped flange-shaped housing portion 45 covering the root portion of the fixing flange portion 33 of the shield shell 31. The front housing portion 42 is arranged in the connector mounting hole 51 of the equipment case 50.

The flange-shaped housing portion 45 overhangs from the front side of the fixing flange portion 33 to cover the rear side. Thus, the fixing between the integrated housing 41 and the shield shell 31 is further enhanced, and the deformation preventing function of the integrated housing 41 in the shield shell 31 is also enhanced. A material having lower rigidity can be used as the resin material for forming the integrated housing 41 by the enhanced deformation preventing mechanism of the flange-shaped housing portion 45.

A ring-shaped seal portion 46 is formed so as to surround the entire circumference of the front housing portion 42 (terminal 21) on the front surface portion of the flange-shaped housing portion 45, that is, on the close contact surface side of the integrated housing 41 with the equipment case 50. The seal portion 46 is formed integrally with the integrated housing 41. The seal portion 46 includes, as shown in FIGS. 2A and 2B, a grid-like elastically deformable wall portion 47 on the close contact surface side with the equipment case 50. The grid-like wall portion 47 protrudes on the close contact surface side with the equipment case 50. A large number of square recessed portions 48 surrounded by the grid-like wall portions 47 are formed. Each of the recessed portions 48 is opened to the close contact surface with the equipment case 50. The seal portion 46 has lower rigidity than the other portions of the integrated housing 41 due to the large number of recessed portions 48, and is elastically deformable. Then, the seal portion 46 is in close contact with the equipment case 50 by the compressive deformation (see FIGS. 3A and 3B).

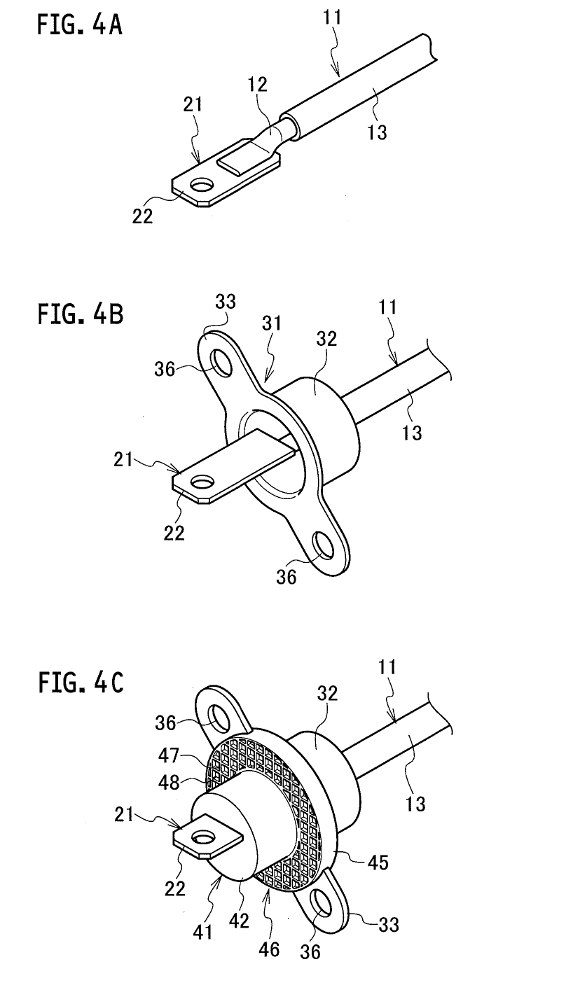

Next, the assembling (producing) procedure of the high-voltage connector 1 will be described with reference to FIGS. 4A to 4C, 2A, and 2B. As shown in FIG. 4A, the terminal 21 is connected to the end portion of the wire 11. As shown in FIG. 4B, in a mold (not shown), the wire 11 and the terminal 21 are set in a predetermined position in the state of being inserted into the shield shell 31. The wire 11, the terminal 21, and the shield shell 31 are set as the insert components, and the integrated housing 41 is molded by, for example, the elastomer-based resin material being injected into a mold (not shown). The grid-like wall portion 47 of the seal portion 46 is formed simultaneously with the molding. Thus, the molded product shown in FIG. 4C is produced.

Lastly, the end portion of the cylindrical shield member (braided wire and the like) is put on the outer surface of the cylindrical-body portion 32 of the shield shell 31, the caulking ring 7 is put thereon, and the caulking ring 7 is caulked, whereby the shield member (braided wire and the like) is connected and fixed, and the assembly of the high-voltage connector 1 (production) is completed (see FIGS. 2A and 2B).

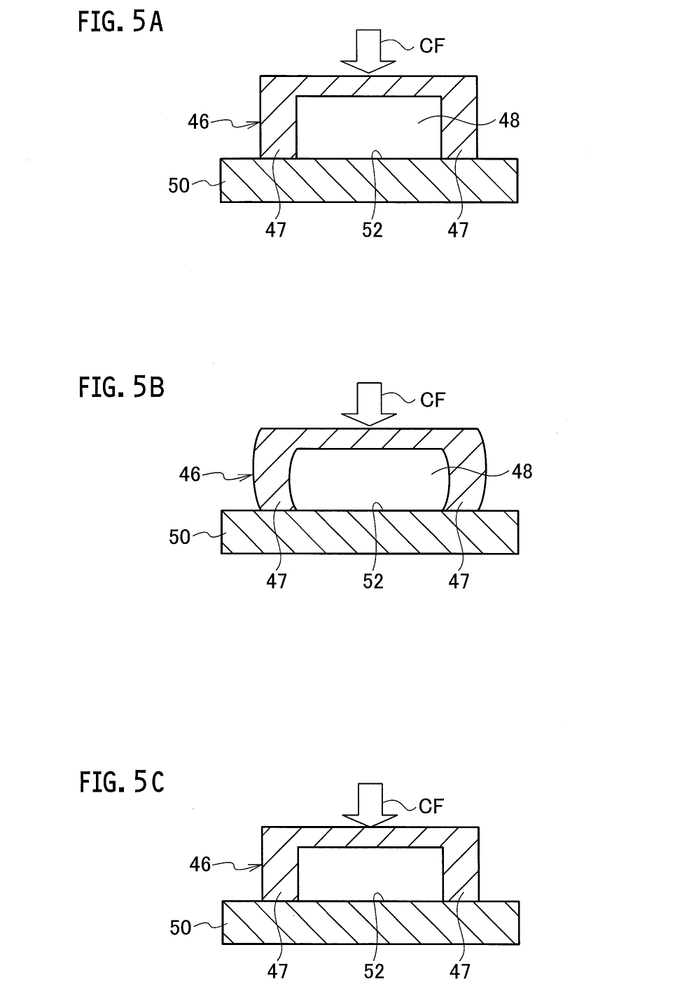

Next, the mounting procedure of the high-voltage connector 1 to the equipment case 50 will be described. The front housing portion 42 of the high-voltage connector 1 is inserted from the outside of the equipment case 50 into the connector mounting hole 51. Then, the terminal 21 protrudes in the equipment case 50, and the seal portion 46 of the integrated housing 41 is arranged in the seal recess 52. Next, the fixing screw (not shown) inserted into the fixing hole 36 of the shield shell 31 is screwed into the equipment case 50, and the high-voltage connector 1 is fastened to the equipment case 50. In the screwing process of the fixing screw, the fastening of the high-voltage connector 1 to the equipment case 50 causes the compressive force CF to act on the seal portion 46 as shown in FIG. 5A, the compressive force CF causes the seal portion 46 (wall portion 47) having lower rigidity than the other portions of the integrated housing 41 to be compressed and deformed (elastically deformed) as shown in FIG. 5B, and the deformation returning force causes the grid-like wall portion 47 of the seal portion 46 to come into close contact with the equipment case 50. In each of the recessed portions 48, the volume is reduced by the compressive deformation of the seal portion 46, and the internal air is discharged to the outside. After the fastening is completed, the seal portion is deformed and returned a little from the maximum compressive deformation, and the volume of the recessed portion 48 is increased. This causes the recessed portion 48 to be sealed by the equipment case 50 (close contact surface of the equipment case 50 with the integrated housing 41), causes the air pressure in the recessed portion 48 (internal pressure) to become lower than the atmospheric pressure (external pressure), and causes the seal portion 46 to stick to the equipment case 50. According to the above, the seal portion 46 comes into close contact with the equipment case 50 by the elastic returning force of the grid-like wall portion 47 and the adsorption force of the recessed portion 48, and seals the boundary between the integrated housing 41 and the equipment case 50 by a strong sealing force.

As described above, in the high-voltage connector 1, the seal portion 46 is molded integrally with the integrated housing 41, and therefore the number of components and the assembling man-hours do not increase. Although the integrated housing 41 is formed of a material having the rigidity at least having the function as the housing, the seal portion 46 has lower rigidity than the other portions of the integrated housing 41 due to a large number of recessed portions 48, and is compressed and deformed (elastically deformed) to come into close contact with the equipment case 50 when subjected to the compressive force CF. According to the above, the seal between the integrated housing 41 and the equipment case 50 can be securely performed without the number of components and the assembling man-hours being increased.

The terminal 21 and the end portion of the wire 11 are overmolded with the insulating resin material, whereby the integrated housing 41 is formed. Therefore, the integrated housing 41 has the holding function of the components to be housed therein and the waterproof function between the components to be held (the terminal 21 and the wire 11). For this reason, the reduction in the number of components of the high-voltage connector 1, the space saving due to this, and eventually the miniaturization of the high-voltage connector 1 can be achieved.

The shield shell 31 as well as the terminal 21 and the end portion of the wire 11 is overmolded with the insulating resin material, whereby the integrated housing 41 is formed. Therefore, the shield shell 31 functions as the rigidity reinforcing member of the integrated housing 41. Thus, the integrated housing 41 is formed of a material having low rigidity as compared to the related connector described above, that is, an elastically deformable material. Then, in the integration of the seal portion 46 in the integrated housing 41, the reduction in rigidity enough to exert the sealing performance (flexibility) due to the formation of the recessed portion 48 is sufficiently provided. According to the above, the seal portion 46 of the integrated housing 41 is compressed and deformed by the fastening force of the high-voltage connector 1 to the equipment case 50, and therefore the deformation of the seal portion 46 depending on the unevenness of the mounting surface is possible. Thus, the seal can be performed with a high sealing force.

Each of the recessed portions 48 of the seal portion 46 is opened to the close contact surface with the equipment case 50. Therefore, the seal portion 46 comes into close contact with the equipment case 50 also by the adsorption force due to the pressure difference between the air pressure in the recessed portion 48 and that of the external air, in addition to the elastic returning force of the compressive deformation, and therefore the sealing performance of the seal portion 46 is improved.

The integrated housing 41 is molded over the shield shell 31, and therefore the flange-shaped housing portion 45 of the integrated housing 41 is in close contact with the surface of the fixing flange portion 33 of the shield shell 31 over the entire area without any gap. Therefore, the fastening force of the fastening member becomes easier to transfer from the fixing flange portion 33 to the flange-shaped housing portion 45, and therefore the sealing performance is improved compared to that of a second embodiment described below.

That is, as in the second embodiment described below, as for the integrated housing 41, when only the terminal 21 and the wire 11 are overmolded and formed by the insulating resin, and the shield shell 31 is fitted by post-fitting into the molded integrated housing 41, there is a possibility that the flange-shaped housing portion 45 of the integrated housing 41 and the surface of the fixing flange portion 33 of the shield shell 31 are not in close contact with each other completely, and that a gap occurs. When there is a gap between the flange-shaped housing portion 45 of the integrated housing 41 and the surface of the fixing flange portion 33 of the shield shell 31, the fastening force of the fastening member is difficult to transmit from the fixing flange portion 33 to the flange-shaped housing portion 45, and the sealing performance is reduced.

The integrated housing 41 is molded over the shield shell 31, and therefore the damage to the integrated housing 41 in the previous process (during coating and transporting), in addition to when the high-voltage connector 1 is mounted to the equipment case 50, can also be prevented.

The grid-like wall portion 47 may be formed by cutting processing or the like after molding. The same applies to the second embodiment described below.

### Second Embodiment

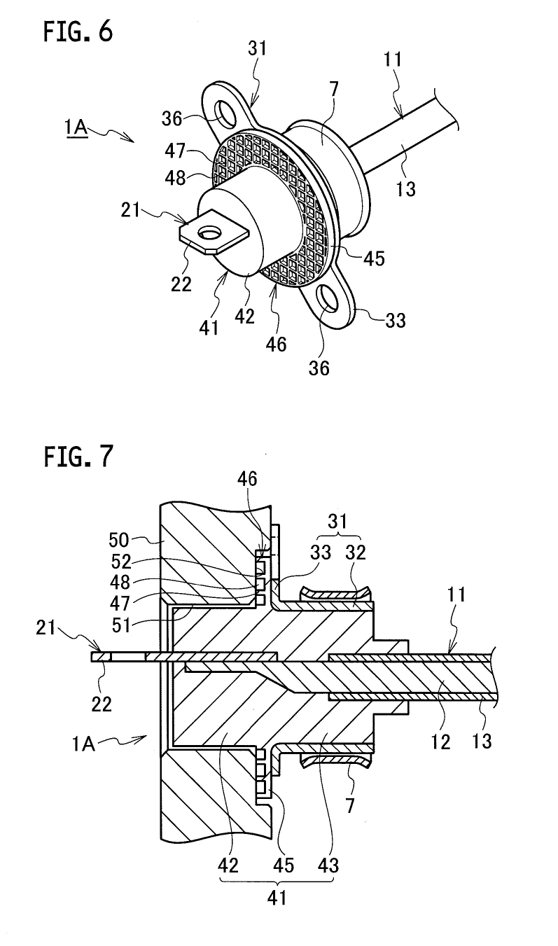

FIGS. 6 to 8C illustrate the second embodiment of the present invention. A high-voltage connector 1A of the second embodiment is different in the following configuration as compared to the high-voltage connector 1 of the first embodiment.

As shown in FIGS. 6 and 7, the terminal 21 and the end portion of the wire 11 are overmolded with the insulating resin material, whereby the integrated housing 41 is formed. The shield shell 31 is fitted by post-fitting on the outer periphery of the integrated housing 41, and is assembled. The shield shell 31 is fitted to the rear housing portion 43 of the integrated housing 41. The shield shell 31 is fixed to the integrated housing 41 by fitting. The fixing flange portion 33 of the shield shell 31 is arranged only on the rear surface of the root portion of the flange-shaped housing portion 45 of the integrated housing 41.

The other configurations are the same as those in the first embodiment, and therefore the same configuration portions of the drawings will be denoted by the same reference numerals, and the description thereof will be omitted. The configuration of the seal portion 46 is the same.

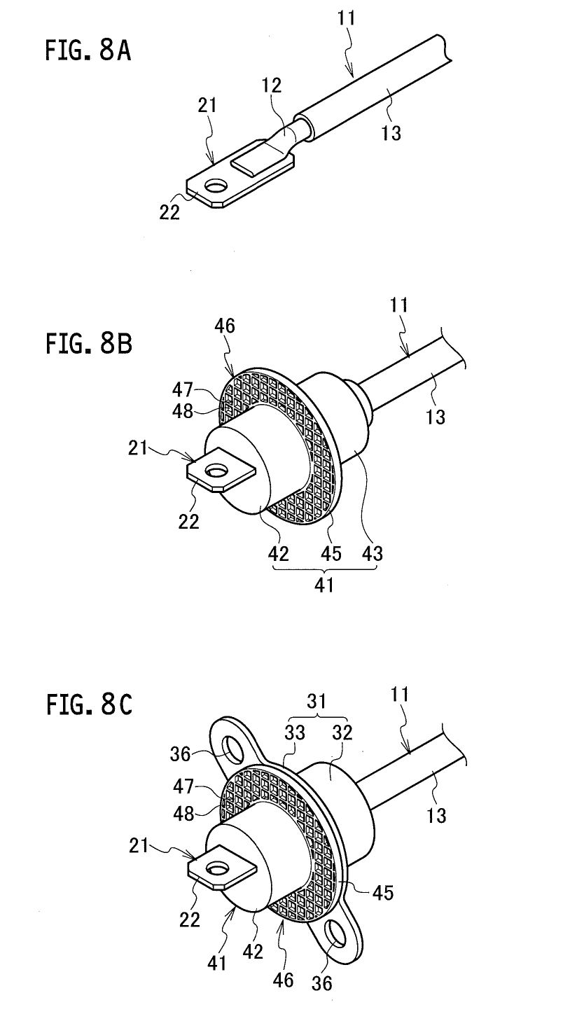

Next, the assembling (producing) procedure of the high-voltage connector 1A of the second embodiment will be described with reference to FIGS. 8A to 8C, and 6. As shown in FIG. 8A, the terminal 21 is connected to the end portion of the wire 11. Next, the wire 11 and the terminal 21 are set at a predetermined position as the insert components, and the integrated housing 41 is molded by, for example, the elastomer-based resin material being injected into a mold (not shown). Thus, the molded product shown in FIG. 8B is produced.

Next, as shown in FIG. 8C, the shield shell 31 is fitted to the rear housing portion 43 from the rear of the integrated housing 41.

Lastly, the end portion of the cylindrical shield member (braided wire and the like) is put on the outer surface of the cylindrical-body portion 32 of the shield shell 31, the caulking ring 7 is put thereon, and the caulking ring 7 is caulked, whereby the shield member (braided wire and the like) is connected and fixed, and the assembly of the high-voltage connector 1A (production) is completed (see FIG. 6).

The mounting procedure of the high-voltage connector 1A to the equipment case 50 is the same as that of the first embodiment, and therefore the description thereof will be omitted.

Also in the second embodiment, for the same reason as in the first embodiment, the seal between the integrated housing 41 and the equipment case 50 can be securely performed without the number of components and the assembling man-hours being increased. In addition, the seal portion 46 exerts a high sealing force for the same reason as in the first embodiment.

The integrated housing 41 is not formed by the shield shell 31 being overmolded with the insulating resin, but is fitted by the shield shell 31 by post-fitting. Therefore, the shield shell 31 fitted by post-fitting functions as the rigidity reinforcing member of the integrated housing 41. Thus, a material having low rigidity compared to the related connector described above will suffice for the rigidity required for the integrated housing 41. As a result, the selection range of the resin material of the integrated housing 41 is widened. In the integration of the seal portion 46 in the integrated housing 41, the reduction in rigidity enough to exert the sealing performance (flexibility) due to the formation of the recessed portion 48 can be sufficiently achieved.

### Third Embodiment

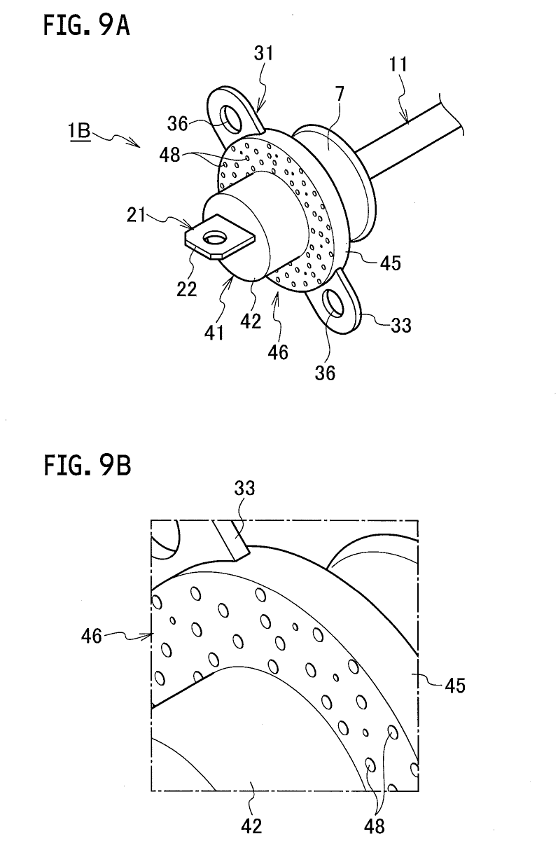

FIGS. 9A to 11C illustrate a third embodiment of the present invention. A high-voltage connector 1B of the third embodiment is different only in the configuration of the seal portion 46 as compared to the high-voltage connector 1 of the first embodiment.

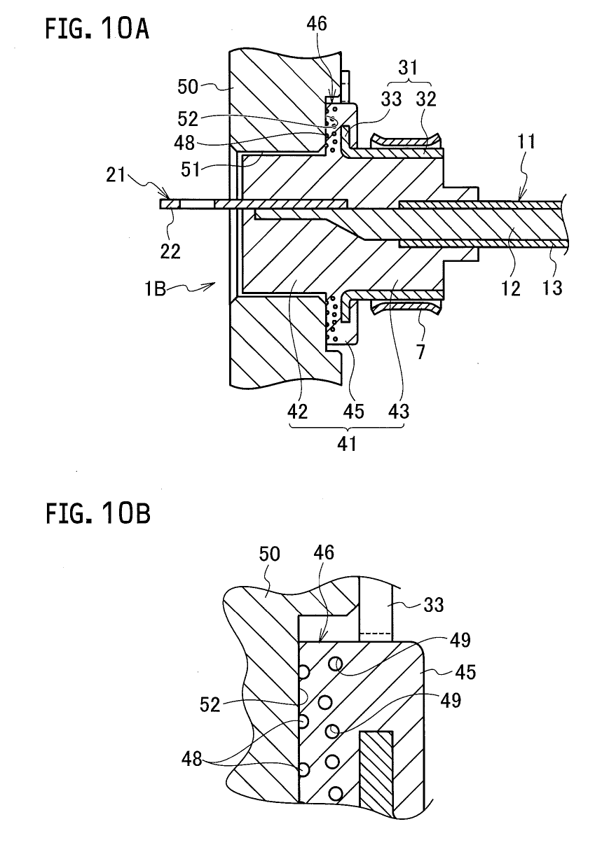

That is, in the seal portion 46, a large number of recessed portions 48 opened to the close contact surface side of the equipment case 50 are formed. The recessed portion 48 is, as described below, formed by causing the air to be involved in the place of the molten resin to be the seal portion 46 during the molding of the integrated housing 41. Due to the production method, a large number of small holes 49 (see FIG. 10B) are formed even inside the seal portion 46.

The seal portion 46 has lower rigidity than the other portions of the integrated housing 41 due to a large number of recessed portions 48 on the front surface side and a large number of internal small holes 49, and is elastically deformable. The seal portion 46 is in close contact with the equipment case 50 by the compressive deformation (see FIGS. 10A and 10B). In the third embodiment, the seal portion 46 is sponge-like, and therefore the rigidity is further lowered, the reaction force is easily obtained, and the close contact performance can be improved, as compared to that in a fourth embodiment described below, that is, that having recessed portions 48 only on the surface.

The other configurations are the same as those in the first embodiment, and therefore the same configuration portions of the drawings will be denoted by the same reference numerals, and the description thereof will be omitted.

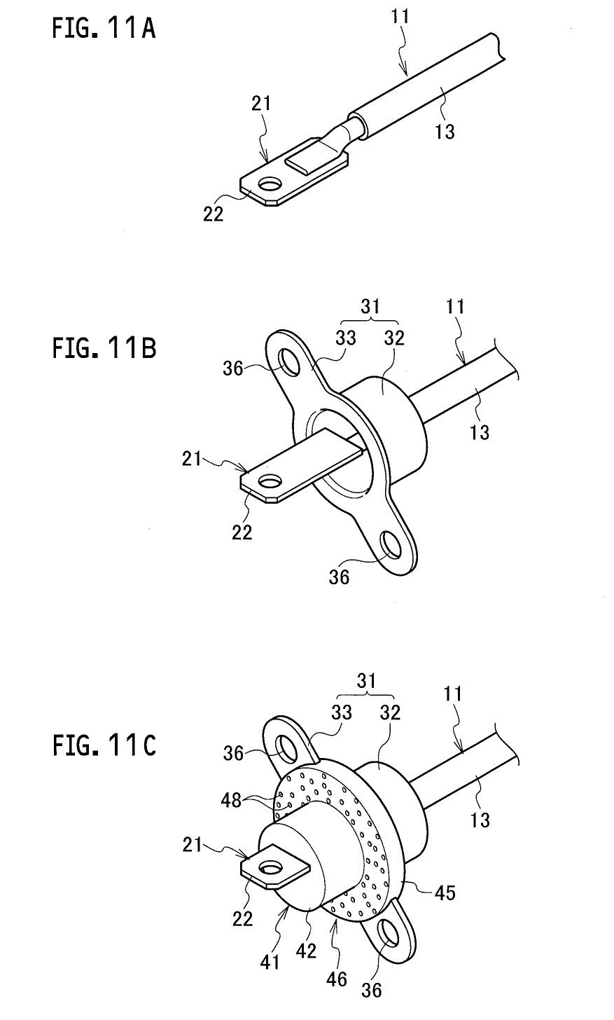

Next, the assembling (producing) processes of the high-voltage connector 1B will be described. As shown in FIG. 11A, the terminal 21 is connected to the end portion of the wire 11. As shown in FIG. 11B, in a mold (not shown), the wire 11 and the terminal 21 are set in a predetermined position in the state of being inserted into the shield shell 31. The wire 11, the terminal 21, and the shield shell 31 are set as the insert components, and the integrated housing 41 is molded by, for example, the elastomer-based resin material being injected into a mold (not shown). Here, the air is involved in the place of the molten resin to be the seal portion 46 during the molding. Thus, the molded product shown in FIG. 11C is produced.

Lastly, the caulking ring 7 is caulked on the outer surface of the cylindrical-body portion 32 of the cylindrical shield shell 31, whereby the shield member (braided wire and the like) is connected and fixed, and the assembly of the high-voltage connector 1B (production) is completed (see FIG. 9A).

Also in the third embodiment, for the same reason as in the first embodiment, the seal between the integrated housing 41 and the equipment case 50 can be securely performed without the number of components and the assembling man-hours being increased.

As in the first embodiment, the seal portion 46 comes into close contact with the equipment case 50 also by the adsorption force due to the pressure difference between the air pressure in the recessed portion 48 and that of the external air, and therefore the seal is performed by the high sealing force.

Also in the third embodiment, in the integrated housing 41, the insulating resin forming the integrated housing 41 fills, without any gap, the outer periphery of the terminal 21 other than the tip portion, the outer periphery of the end portion of the wire 11, and the inner periphery of the shield shell 31. Therefore, for the same reason as in the first embodiment, the shield shell 31 and the like functions as the rigidity reinforcing member of the integrated housing 41. Thus, a material having low rigidity compared to the related connector described above will suffice for the rigidity required for the integrated housing 41. Thus, the selection range of the resin material of the integrated housing 41 is widened. In the integration of the seal portion 46 in the integrated housing 41, the reduction in rigidity enough to exert the sealing performance (flexibility) due to the formation of the recessed portion 48 is sufficiently provided.

### Fourth Embodiment

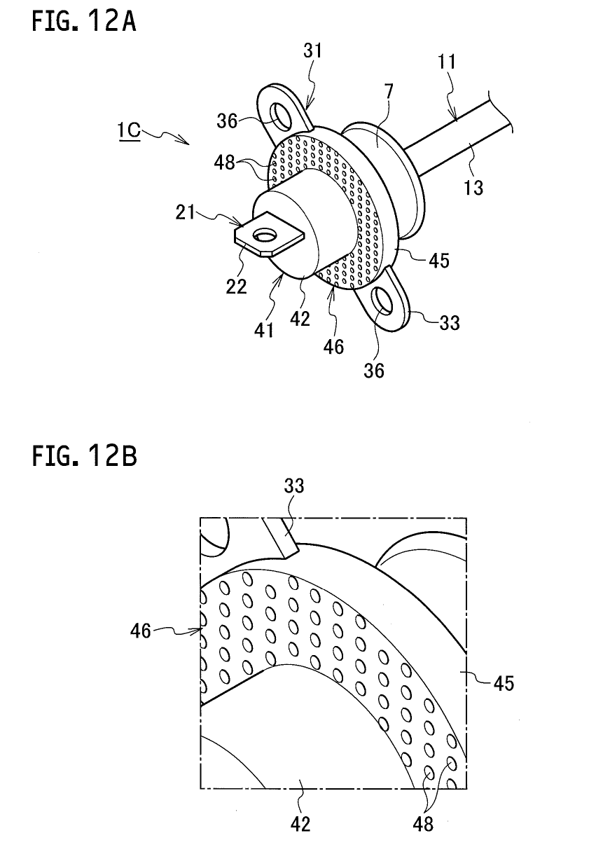

FIGS. 12A to 14C illustrate the fourth embodiment of the present invention. A high-voltage connector 1C of the fourth embodiment is different only in the configuration of the seal portion 46 as compared to the high-voltage connector 1 of the first embodiment.

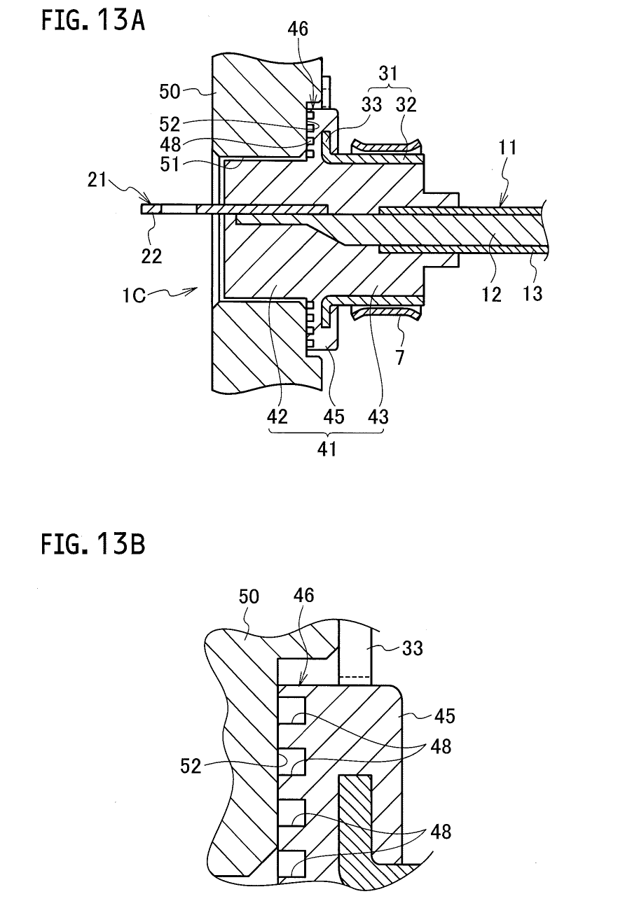

That is, in the seal portion 46, as in the third embodiment, a large number of recessed portions 48 opened to the close contact surface in close contact with the equipment case 50 are formed. Each of the recessed portions 48 has a circular hole, and the recessed portions 48 are regularly formed in a position equally spaced from each other. The recessed portion 48 is formed simultaneously with the molding of the integrated housing 41. The seal portion 46 has lower rigidity than the other portions of the integrated housing 41 due to the large number of recessed portions 48, and is elastically deformable. Then, the seal portion 46 is in close contact with the equipment case 50 by the compressive deformation (see FIGS. 13A and 13B).

The other configurations are the same as those in the first embodiment, and therefore the same configuration portions of the drawings will be denoted by the same reference numerals, and the description thereof will be omitted.

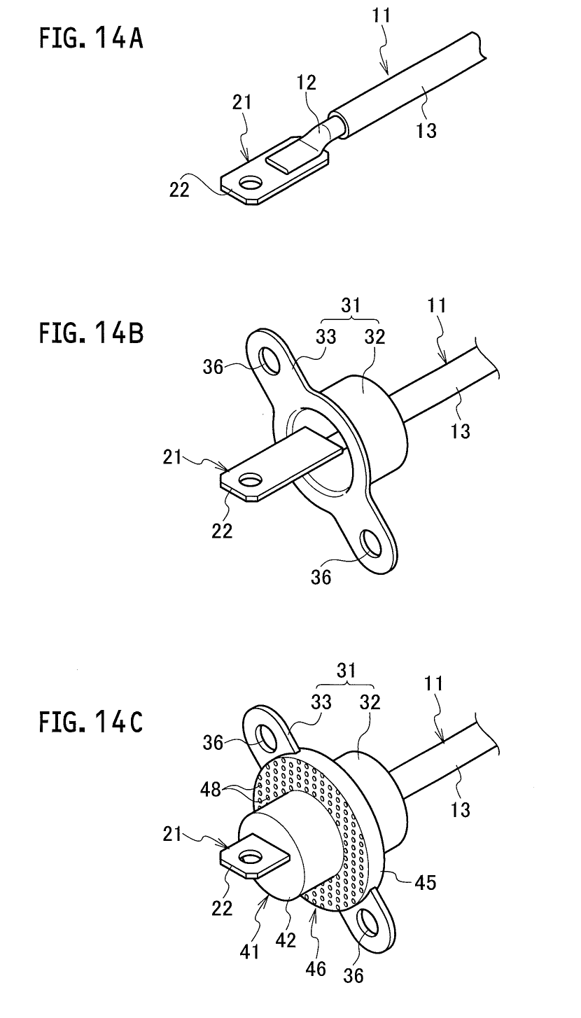

Next, the assembling processes of the high-voltage connector 1C will be described. As shown in FIG. 14A, the terminal 21 is connected to the end portion of the wire 11. As shown in FIG. 14B, in a mold (not shown), the wire 11 and the terminal 21 are set in a predetermined position in the state of being inserted into the shield shell 31. The wire 11, the terminal 21, and the shield shell 31 are set as the insert components, and the integrated housing 41 is molded by, for example, the elastomer-based resin material being injected into a mold (not shown). A large number of recessed portions 48 of the seal portion 46 is formed simultaneously with the molding.

Lastly, the caulking ring 7 is caulked on the outer surface of the cylindrical-body portion 32 of the shield shell 31, whereby the shield member (braided wire and the like) is connected and fixed, and the assembly of the high-voltage connector 1C (production) is completed (see FIG. 12A).

Also in the fourth embodiment, for the same reason as in the first embodiment, the seal between the integrated housing 41 and the equipment case 50 can be securely performed without the number of components and the assembling man-hours being increased.

As in the first embodiment, the seal portion 46 comes into close contact with the equipment case 50 also by the adsorption force due to the pressure difference between the air pressure in the recessed portion 48 and that of the external air, and therefore the seal is performed by the high sealing force.

Also in the fourth embodiment, in the integrated housing 41, the insulating resin forming the integrated housing 41 fills, without any gap, the outer periphery of the terminal 21 other than the tip portion, the outer periphery of the end portion of the wire 11, and the inner periphery of the shield shell 31. Therefore, for the same reason as in the first embodiment, the shield shell 31 and the like functions as the rigidity reinforcing member of the housing 41. Thus, a material having low rigidity compared to the related connector described above will suffice for the rigidity required for the integrated housing 41. As a result, the selection range of the resin material of the integrated housing 41 is widened. In the integration of the seal portion 46 in the integrated housing 41, the reduction in rigidity enough to exert the sealing performance (flexibility) due to the formation of the recessed portion 48 is sufficiently provided.

The recessed portions 48 are freely adjustable in size and number. Therefore, the ratio of the recessed portion 48 to the close contact surface is varied depending on the rigidity of the integrated housing 41, whereby the seal portion 46 can obtain the desired rigidity (flexibility). The number of the recessed portions 48 is varied depending on the size of the recessed portion 48, whereby the seal portion 46 can obtain the desired rigidity (flexibility).

In the formation of the recessed portion 48 by the mold, there is a limit to the size of the recessed portion 48 (a diameter of about 1.0 mm for a circular hole). Therefore, the recessed portion 48 may be formed by laser processing or the like after molding, rather than the recessed portion 48 being formed by molding. In this case, the recessed portion 48 does not have any limit to the size (diameter of about 10 microns is also available) and the shape, and can be freely formed. In the case of laser processing, the recessed portion 48 can be formed even when the integrated housing 41 has a high-hardness material.

### Modifications

In the first, third, and fourth embodiments, the terminal 21, the end portion of the wire 11, and the shield shell 31 are overmolded with the insulating resin material, whereby the integrated housing 41 is formed. In the second embodiment, the terminal 21 and the end portion of the wire 11 are overmolded with the insulating resin material, whereby the integrated housing 41 is formed, then the shield shell 31 is fitted. In any of the embodiments, the shield shell 31 has a rigidity reinforcing function on the integrated housing 41, and a material having low rigidity compared to the related connector described above will suffice for the rigidity required for the integrated housing 41. Thus, in the integration of the seal portion 46 in the integrated housing 41, the reduction in rigidity enough to exert the sealing performance (flexibility) due to the formation of the recessed portion 48 can be sufficiently achieved. However, also for reasons other than those described above, the present invention is also applicable when the housing can be formed of a material having low rigidity compared to the related connector.

In each of the embodiments, the seal portion 46 formed integrally with the integrated housing 41 is obtained by the rigidity reducing processing being performed by the recessed portion 48. Therefore, the recessed portion 48 includes all the embodiments where the rigidity of the seal portion 46 is reduced. Although the recessed portions 48 in the respective embodiments are independent of each other, two or more of those may be in communication.

In this way, the present invention includes various embodiments not described above. Therefore, the scope of the present invention is determined only by the invention identification matters according to claims reasonable from the foregoing description.

What is claimed is:

1. A connector comprising:
a wire;
a terminal to which the wire is connected; and
a housing fixed to a mounting member with the housing holding the terminal, wherein
the housing has a seal portion configured to seal a boundary between the housing and the mounting member in close contact with the mounting member, and
the seal portion includes
a wall portion being elastically deformable, formed integrally with the housing on a close contact surface side of the housing with the mounting member, and protruding to a close contact surface of the mounting member with the seal portion, and
a recessed portion surrounded by the wall portion.

2. The connector according to claim 1, wherein the housing is a housing having an insulating resin overmolding the terminal and the wire.

3. The connector according to claim 1, further comprising a shield shell configured to fix the housing to the mounting member with the seal portion being elastically deformed,
wherein the housing is a housing having an insulating resin overmolding the terminal, the wire, and the shield shell.

4. The connector according to claim 1, wherein the recessed portion opens to the close contact surface of the mounting member with the seal portion.

5. The connector according to claim 3, wherein the shield shell is configured to prevent deformation of an outer shape of the housing.

6. The connector according to claim 3, wherein an outer periphery of the terminal other than a tip portion of the terminal, an outer periphery of an end portion of the wire, an inner periphery of a cylindrical-body portion of the shield shell, and a periphery of a root portion of a fixing flange of the shield shell are filled with the insulating resin without any gap.

7. The connector according to claim 1, wherein the wall portion of the housing fixed to the mounting member is in pressure contact with the close contact surface of the mounting member with the seal portion with the wall portion being compressed and deformed.

8. The connector according to claim 1, wherein an internal pressure of the recessed portion of the housing fixed to the mounting member sealed by the mounting member is lower than an external pressure outside the recessed portion.
